(19) United States
(12) Patent Application Publication
(10) Pub. No.: US 2007/0131345 A1
(43) Pub. Date: Jun. 14, 2007

(54) Optical film packaging format

(76) Inventors: Naoki Nakayama, Tendo-City (JP); Ichiro Hisamoto, Kurihara City (JP)

Correspondence Address: 3M INNOVATIVE PROPERTIES COMPANY, PO BOX 33427, ST. PAUL, MN, 55133-3427, US

(21) Appl. No.: 11/297,614

(22) Filed: Dec. 8, 2005

(51) Int. Cl. B32B 38/00; B32B 37/00

(52) U.S. Cl. 156/249; 156/273.1; 156/306.3

(57) ABSTRACT

An optical film stack includes a plurality of optical films held together by electrostatic force. Liners, which may also be held to the optical film stack by electrostatic force, protect the optical film stack to form an optical film unit. Multiple optical films may be stacked onto each other and efficiently assemble into an optical display. In addition, the optical film stack has no exposed adhesive, which tends to collect dust and particles or transfer to other parts of the display if the edges of the optical films are misaligned relative to each other.

### BACKGROUND OF THE INVENTION

The present invention relates to optical displays. In particular, the present invention relates to pre-stacked optical films for assembly into an optical display.

Optical displays, such as backlit liquid crystal displays (LCDs), are used in a wide variety of applications including mobile telephones, personal digital assistants (PDAs), electronic games, laptop computers, monitors and television screens. Optical films are stacked within an optical display in order to enhance brightness and improve display performance without sacrificing battery life.

Currently, films used in displays are provided as individual films to display manufacturers. During assembly of a display, the cover films of the optical films are removed, and the films are deionized to remove dust particles. Each optical film is then stacked, one by one, into a frame that fits between a back light assembly and an LCD panel. In some cases, each optical film is laminated onto an adjacent optical film by an adhesive layer, but misalignment of optical films resulting from positioning inaccuracies of the laminating machine results in areas of exposed adhesive. The exposed adhesive easily becomes covered with dust and may be transferred to other sets of optical films. In addition, differences in thermal expansion ratios between different optical films may result in warping when laminated together with adhesive. Thus, resolving these problems would increase product output and reduce the number of damaged products.

### BRIEF SUMMARY OF THE INVENTION

The present invention is an optical film unit and a method of making the optical film unit in which stacked optical films and liners are held together by electrostatic force.

### BRIEF DESCRIPTION OF THE DRAWINGS

FIG. 1 is a front view of a representative embodiment of an optical film unit for use in a display in accordance with the present invention.

FIG. 2 is a perspective view illustrating a method of making optical film units in accordance with the present invention.

FIG. 3 is a schematic diagram of a representative device for charging optical films.

### DETAILED DESCRIPTION

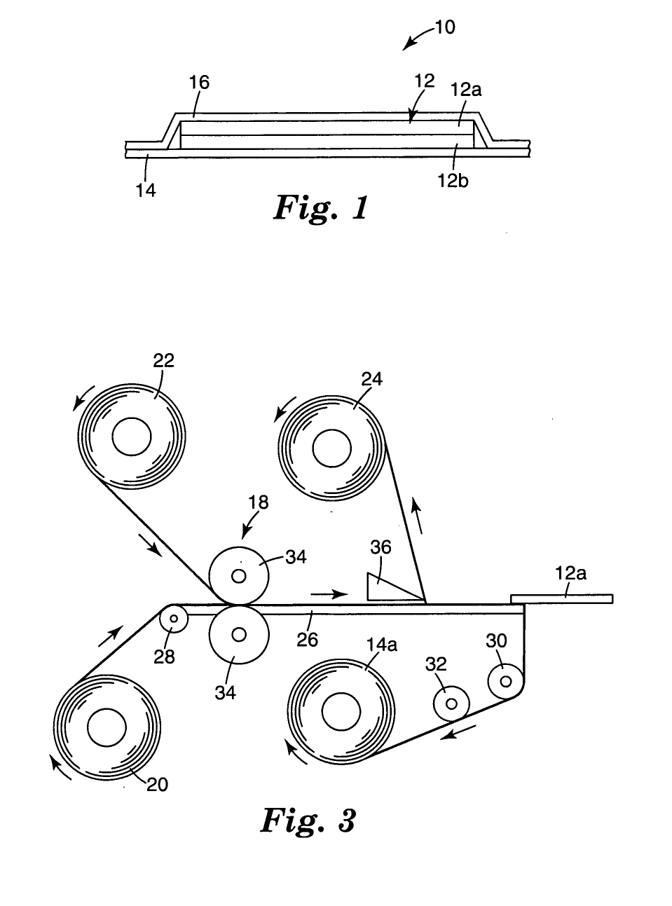

FIG. 1 is a front view showing an optical film unit 10 in accordance with the present invention. Optical film unit 10 includes optical film stack 12 (including optical films 12a and 12b), liner 14 and liner 16. Liners 14 and 16 are protective coverings and can be made from the same or different materials, which are known in the art.

Optical film 12a is placed on liner 14 followed by optical film 12b and then liner 16. As will be described in more detail below, components of unit 10 are held together by electrostatic force so that adhesive need not be applied to optical films 12a and 12b.

In use, liner 16 is removed from optical film stack 12 and liner 14. Optical film stack 12 is subsequently removed from liner 14 and assembled into an optical display, such as an LCD, between the optical light guide and liquid crystal panel. Holding the optical films together prior to installation into an optical display decreases the time and cost associated with assembly of the optical display by avoiding individually inserting each film.

Although optical film unit 10 is shown having two optical films, 12a and 12b, there is no limit as to the number of films that may be stacked, and the number of optical films will vary depending on the display in which it is used. Some or all of the optical films may be of the same type, again, depending on the optical display. Examples of the types of optical films that may be used in the present invention include light directing films, turning films, multi-layer polymer films, diffuser-type films, reflective films, etc.

In addition, during placement of optical film 12b onto optical film 12a, the edges of optical films 12a and 12b may be misaligned relative to each other due to positioning inaccuracies of the robotic devices used to stack the films. But because there is no adhesive placed on the optical films, exposed edges of the films are not covered with dust, and adhesive is not transferred to other optical films or parts of the display, which may interfere with viewing.

Installation of optical film stack 12 into an optical display can be performed using an automated assembly line and may reduce the amount of debris between and damage to the films, because the manufacturer does not individually install the films. Reduced thickness of the stacked optical films is also an advantage of the present invention. A recent trend in backlit displays is toward thinner modules. The lack of adhesive provides for thinner stacked films, which allows for a thinner design.

In addition, differences in thermal expansion ratios of the various types of optical films can lead to warping within the display. The free-flow properties of optical films stacked without adhesive will alleviate warping.

It should be noted that embodiments of the present invention also encompass only charging one or some of the optical films of the stack or the use of adhesive between some optical films. In some instances, it may be desirable to have greater adhesion between some of the stacked optical films. In those cases, an adhesive can be applied only to those films requiring greater adhesion, while using electrostatic force to hold the remaining optical films.

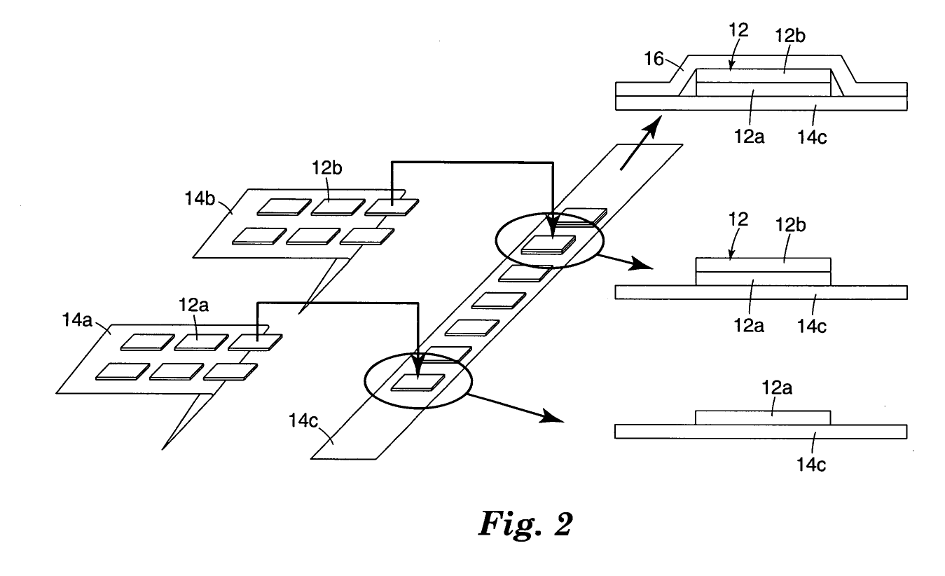

FIG. 2 is a representative embodiment of the method of making the present invention. Optical films 12a and 12b are shown attached to liners 14a and 14b, respectively. Initially, a third liner also covered films 12a and 12b on liners 14a and 14b. The third liner was removed just prior to the stage of the method shown in FIG. 2.

Next, optical film 12a is removed from liner 14a. Typically, optical film 12a acquires a charge during removal of the third liner, liner 14a or both, which is described in more detail below. Optical film 12a is then placed on liner 14c either manually with a gloved hand or by a robotic arm with a silicone rubber pick-up head to reduce charge dissipation from film 12a. When charged optical film 12a is placed on neutral liner 14, the charge within optical film 12a and liner 14 moves to create a neutral charge at the interface between film 12a and liner 14. So for example, when film 12a acquires a negative charge and is placed on liner 14, the negative charge will migrate toward liner 14. In turn, at the interface liner 14 takes on a positive charge so that film 12a and liner are attracted to each other and hold together.

In an alternate embodiment, optical film 12a may be charged after it is picked from liner 14a instead of using the charge gained during removal of the liners. With either embodiment, if desired, equipment may be engineered to control the amount of charge gained by the films.

Next, liner 14b is removed from optical film 12b, and film 12b is placed onto film 12a to form optical film stack 12. Optical film 12b acquires a charge and is picked and placed as described for film 12a. Film 12b is held to film 12a by migration of charge. When film 12b acquires its negative charge and is placed on film 12a, its negative charge will move toward the interface between films 12a and 12b, because the surface of film 12a at this interface has taken on a relatively more positive charge.

Lastly, liner 16 is placed over optical film 12b such that it covers optical film stack 12 and liner 14c. Again, the drive to create a neutral interface between the layers forces migration of charges such that film 12b and liner 16 hold together.

FIG. 3 illustrates a representative method of charging optical films. As briefly described regarding FIG. 2, the optical films typically acquire a charge by removing liners from the individual films prior to forming optical film stack 12.

FIG. 3 includes device 18 for removing the liners from the optical films, liner 14a, optical film 12a, optical film strip 20, weeding tape 22 and weed 24. Device 18 further includes support 26, idlers 28, 30 and 32, laminating station 34 and stripper bar 36. Optical film strip 20 is essentially a web of optical film material between liner 14a and a top liner that has been kiss-cut through the top liner and optical film material to form optical films 12a.

In operation, optical film strip 20 is fed into device 18 and supported through device 18 by support 26. Idler 28 guides strip 20 and weeding tape 22 into laminating station 34 to laminate weeding tape 22 onto strip 20. Stripper bar 36 then removes weed 24, which includes weeding tape 22, the top liner and waste optical film material. Lastly, idlers 30 and 32 guide liner 14a such that it is removed from optical film 12a. Optical film 12a, at this point, has acquired a charge through the process of removing the liners. In the embodiment shown in FIG. 3, film 12a is not deionized to remove dust and debris prior to stacking. In order to prevent contamination by dust and debris during the charging process, charging must be performed in a clean area free of contaminants.

The resulting charge on film 12a is generated by friction of the liner and weeding tape materials during the dispensing process. To illustrate this phenomenon, voltage measurements were taken and the results are shown at various points in FIG. 3. As strip 20 was unwound, charges of +20 kv and +10 kv were generated by the unwinding process. As weeding tape 22 was unwound, charges of +50 kv, +20 kv, +10 kv and +7 kv were generated during unwinding. The charge measured at laminating station 34 was −30 kv and −80 kv. Charges of +50 kv, +30 kv and +60 kv were measured at points where weed 24 passed around stripper bar 36 and was subsequently wound. As liner 14a was removed from optical film 12a and wound, charges of 0 kv, +40 kv and +60 kv were measured. The resulting charge on optical film 12a was −20 kv.

### EXAMPLE

An optical film unit having two optical films was produced by the method of the present invention. The liners were both LD-1010-75 by Hitach Chem., and the two optical films were thin-BEF by 3M Company. The optical film unit was fed into a 3M dispenser and tested for dispensability and parts handling. No issues regarding contamination, alignment, warping or loss of electrostatic properties were identified.

The present invention provides several advantages. The process simplifies the manufacture of optical displays resulting in gains in efficiency with respect to cost, including fewer damaged films, and time. In addition, the optical films, without adhesive, result in thinner optical film stacks and have free flow properties after assembling into the backlight unit that reduce warping. In addition, it alleviates issues surrounding misalignment of stacked optical films.

Although the present invention has been described with reference to preferred embodiments, workers skilled in the art will recognize that changes may be made in form and detail without departing from the spirit and scope of the invention.

1. A method of producing an optical film stack, the method comprising:
charging a first optical film; and
placing a second optical film on the charged first optical film to form a stack;
wherein the first and second optical films are held together by electrostatic force and without adhesive.

2. The method of claim 1 wherein charging further comprises:
removing at least one liner from the first optical film.

3. The method of claim 2 wherein the liner is removed by weeding tape.

4. The method of claim 3 wherein the charge is generated by friction of the liner and weeding tape.

5. The method of claim 1 wherein the first optical film is charged in an area free of dust and debris contaminants.

6. The method of claim 1 and further comprising:
placing the charged first optical film on a first liner; and
covering the second optical film and first liner with a second liner.

7. The method of claim 1 wherein the first and second optical films are one of light directing films, turning films, diffuser-type films, multi-layer polymer films and reflective films.

8. The method of claim 1 and further comprising:
charging the second optical film.
